(19) United States
(12) Patent Application Publication
(10) Pub. No.: US 2019/0236586 A1
(43) Pub. Date: Aug. 1, 2019

(54) Payment Processing Method and Apparatus

(71) Applicant: Huawei Technologies Co., Ltd., Shenzhen, Guangdon (CN)

(72) Inventor: Jingqing Mei, Beijing (CN)

(21) Appl. No.: 16/320,360

(22) PCT Filed: May 26, 2017
(86) PCT No.: PCT/CN2017/086215

§ 371 Date: Jan. 24, 2019

(30) Foreign Application Priority Data
Feb. 16, 2017 (CN) 201710084631.X

(51) Int. Cl. G06Q 20/32; G06Q 20/34; G06Q 20/40

(52) U.S. Cl. CPC G06Q 20/3278; G06Q 20/401; G06Q 20/34

(57) ABSTRACT

A payment processing method and apparatus, where the payment processing method includes obtaining by a payee terminal, transaction information of a payment card application, determining, by the payee terminal based on the transaction information, that a running environment of the payment card application is a mobile terminal device; and sending, by the payee terminal, payment voucher information of the payment card application to the mobile terminal device using a first communications technology, where the first communications technology includes a short range communications technology. Hence, a user can conveniently manage and view payment voucher information.

### TECHNICAL FIELD

The present invention relates to the field of communications technologies, and in particular, to a payment processing method and apparatus.

### BACKGROUND

Currently, a card swiping transaction has become a very universal form of payment all over the world, each merchant is equipped with a payee terminal, for example, a point of sale (Point of Sale, POS) machine. A user can make a payment by inserting a bank card into the POS machine or making a bank card close to the POS machine. A specific payment process is: The POS machine interacts with an application in the bank card, and the POS machine obtains transaction information of the bank card, and is connected to a bank server to implement payment.

As communications technologies develop, making a payment by using a mobile terminal also gradually becomes a commonly used payment manner. To be specific, a mobile terminal may be used as a bank card. A specific payment process may be: An application of the mobile terminal interacts with the POS machine, and the POS machine obtains transaction information of a bank card added to the application of the mobile terminal, and is connected to a bank server to implement payment. Currently, applications of the mobile terminal that are commonly used for payment are Apple Pay, Huawei Pay, and the like.

Regardless of whether a bank card or a mobile terminal is used for payment, after a payment transaction is completed, a POS machine usually prints a bank sales slip as a payment voucher of the transaction. For daily purchase, it is relatively complex to keep a paper bank sales slip, and a resource waste is also caused because the paper bank sales slip is not used in most cases.

### SUMMARY

Embodiments of the present invention provide a payment processing method and apparatus, so that a resource waste can be avoided, and a user can conveniently manage and use the payment voucher information.

According to a first aspect, an embodiment of the present invention provides a payment processing method. The payment processing method specifically includes: A payee terminal obtains transaction information of a payment card application. The transaction information may be information that is about the payment card application and that is obtained based on a transaction procedure of a financial integrated circuit (Integrated Circuit, IC) card transaction standard specified by the EMVCo, the People's Bank of China (People's Bank of China, PBOC), or the like.

The payee terminal determines, based on the transaction information, that a running environment of the payment card application is a mobile terminal device, in other words, determines that a user makes a payment by using the payment card application of the mobile terminal device. The payee terminal sends payment voucher information of the payment card application to the mobile terminal device by using a first communications technology. The first communications technology may include a short range communications technology, such as a near field communication (Near Field Communication, NFC) technology, a Bluetooth communications technology, or a Wireless Fidelity direct (Wi-Fi Direct) technology.

In a possible design, the payee terminal sends the payment voucher information of the payment card application to the mobile terminal device based on the NFC technology. For example, the payee terminal and the mobile terminal use an NFC connection established during transmission of the transaction information, and the payee terminal is used as an NFC card reader, and sends the payment voucher information of the payment card application to the mobile terminal device. Alternatively, the payee terminal is currently disconnected from the mobile terminal device, re-establishes an NFC P2P connection, and sends the payment voucher information of the payment card application to the mobile terminal device. Alternatively, the payee terminal is currently disconnected from the mobile terminal device, the payee terminal uses the payment voucher information of the payment card application as content of an NFC tag, and the payment terminal is used as a card reader to read the NFC tag, to obtain the content in the NFC tag.

In a possible design, the payee terminal may exchange handover information of a target bearer connection with the mobile terminal device based on the NFC technology, and re-establishes the target bearer connection between the payee terminal and the mobile terminal device based on the handover information. The payee terminal sends the payment voucher information of the payment card application to the mobile terminal device over the target bearer connection. The target bearer connection may be a short range communication connection other than NFC.

In a possible design, a determining manner in which the payee terminal determines, based on the transaction information, that the running environment of the payment card application is the mobile terminal device may be: The payee terminal detects whether the transaction information includes at least one type of key information. Types of the key information may include: indication information used to indicate that the payment card application supports a terminal cardholder verification method, indication information used to indicate that the payment card application is successfully verified by a terminal cardholder, and digital information that meets a preset encoding rule and that is included in a personal account number of the payment card application. The preset encoding rule may be an encoding rule exclusive to the personal account number of the payment card application of the mobile terminal device.

If the transaction information includes the at least one type of key information, the payee terminal determines that the running environment of the payment card application is the mobile terminal device.

In a possible design, a determining manner in which the payee terminal determines, based on the transaction information, that the running environment of the payment card application is the mobile terminal device may be: The payee terminal detects whether the transaction information includes first indication information. The first indication information is used to indicate that the running environment of the payment card application is the mobile terminal device.

If the transaction information includes the first indication information, the payee terminal determines that the running environment of the payment card application is the mobile terminal device.

In a possible design, a determining manner in which the payee terminal determines, based on the transaction information, that the running environment of the payment card application is the mobile terminal device may be: The payee terminal obtains an identifier of the payment card application from the transaction information; the payee terminal sends the identifier of the payment card application to a server; and the server may determine, based on the identifier of the payment card application, whether the running environment of the payment card application is the mobile terminal device. For example, if the server stores a correspondence between an identifier of each payment card application and a running environment, the server may determine the running environment of the payment card application based on the identifier of the payment card application.

Optionally, the identifier of the payment card application may be the personal account number exchanged between the payment card application and the payee terminal. It should be noted that when a bank card is added to the payment card application of the mobile terminal device, and the personal account number is exchanged between the payment card application of the mobile terminal device and the payee terminal, the personal account number is no longer a personal account number of the bank card, but a temporary personal account number that corresponds to the personal account number of the bank card and that is allocated by the server. The temporary personal account number may be updated or replaced. The server stores a correspondence between the personal account number of the bank card and the temporary personal account number.

When the server determines, based on the identifier of the payment card application, that the running environment of the payment card application is the mobile terminal device, the server returns second indication information to the payee terminal, and the payee terminal receives the second indication information returned by the server. The second indication information is used to indicate that the running environment of the payment card application is the mobile terminal device.

In a possible design, if the payee terminal determines, based on the transaction information, that the running environment of the payment card application is a physical card, the payee terminal processes the payment voucher information of the payment card application.

That the payee terminal processes the payment voucher information of the payment card application includes:

printing, by the payee terminal, the payment voucher information of the payment card application; and/or

sending, by the payee terminal by using a second communications technology, the payment voucher information of the payment card application to a receiving account bound to the physical card, such as a mailbox or another mobile phone application with a capability of receiving the payment voucher information, where the second communications technology includes any one of a cellular communications technology, a wired communications technology, and a wireless local area network Wi-Fi technology.

A determining manner in which the payee terminal determines, based on the transaction information, that the running environment of the payment card application is the physical card may be: The transaction information includes indication information used to indicate that the running environment of the payment card application is the physical card; and/or a personal account number in the transaction information does not include digital information that meets a preset encoding rule; and/or the payee terminal uploads an identifier of the payment card application in the transaction information to a server, the server determines, based on the identifier of the payment card application, that the running environment of the payment card application is the physical card, and the server sends, to the payee terminal, the indication information used to indicate that the running environment of the payment card application is the physical card.

In a possible design, before the payee terminal processes the payment voucher information of the payment card application, the payee terminal outputs selection information. The selection information is used to instruct the user to select a processing manner of processing the payment voucher information of the payment card application.

The payee terminal obtains a select instruction that is selected by the user for the selection information, and determines the processing manner corresponding to the select instruction. For example, if a select instruction indicating that the user selects a paper payment voucher is detected, the payee terminal prints the payment voucher information of the payment card. If a select instruction indicating that the user selects an electronic payment voucher is detected, the payee terminal sends, by using the second communications technology, the payment voucher information of the payment card to the receiving account bound to the physical card, such as an email address. If a select instruction indicating that the user selects an electronic payment voucher and a paper payment voucher is detected, the payee terminal prints the payment voucher information of the payment card, and sends, by using the second communications technology, the payment voucher information of the payment card to the receiving account bound to the physical card.

A second aspect of the embodiments of the present invention provides a payment processing apparatus, including an obtaining unit, a processing unit, and a sending unit. The obtaining unit is configured to obtain transaction information of a payment card application. The processing unit is configured to determine, based on the transaction information, that a running environment of the payment card application is a mobile terminal device. The sending unit is configured to send payment voucher information of the payment card application to the mobile terminal device by using a first communications technology. The first communications technology includes a short range communications technology.

A third aspect of the embodiments of the present invention provides a payment processing apparatus, including a transceiver, a processor, and a memory. The payment processing apparatus is a specific structure that carries the function modules in the second aspect.

The memory is configured to store a computer program instruction.

The processor is coupled to the memory, and is configured to: read the computer program instruction stored in the memory, and perform the method provided in the first aspect.

A fourth aspect of the embodiments of the present invention provides a program storage medium. When a program stored in the program storage medium is executed, the method provided in the first aspect may be implemented.

In the embodiments of the present invention, during transaction processing between the payee terminal and the payment card application, the payee terminal obtains the transaction information of the payment card application. The payee terminal further determines, based on the transaction information, that the running environment of the payment card application is the mobile terminal device. The payee terminal sends the payment voucher information of the payment card application to the mobile terminal device by using the short range communications technology. In this manner, when it is determined that the running environment of the payment card application is the mobile terminal device, it indicates that the user takes the mobile terminal device along. The payee terminal sends the payment voucher information of the payment card application to the mobile terminal device by default, so that the user conveniently manages and views the payment voucher information. In addition, a manner of sending the payment voucher information to the mobile terminal device by using the short range communications technology does not need to depend on network coverage, and has a wide application range.

### BRIEF DESCRIPTION OF DRAWINGS

To describe the technical solutions in the embodiments of the present invention or in the background more clearly, the following describes the accompanying drawings required for describing the embodiments of the present invention or the background.

FIG. 1 is an interaction flowchart of a payment processing method according to an embodiment of the present invention;

FIG. 2 is an interaction diagram of determining a running environment of a payment card application according to an embodiment of the present invention;

FIG. 3 is another interaction diagram of determining a running environment of a payment card application according to an embodiment of the present invention;

FIG. 4 is still another interaction diagram of determining a running environment of a payment card application according to an embodiment of the present invention;

FIG. 5 is a schematic structural diagram of a payee terminal according to an embodiment of the present invention; and

FIG. 6 is a schematic structural diagram of another payee terminal according to an embodiment of the present invention.

### DESCRIPTION OF EMBODIMENTS

The following describes the embodiments of the present invention with reference to the accompanying drawings in the embodiments of the present invention.

A payment card application in the embodiments of the present invention may run on a mobile terminal. Alternatively, the payment card application may run in a physical card, and the physical card may be a bank card (such as a debit card or a credit card). When the payment card application runs on the mobile terminal, the payment card application stores transaction information of a bank card, and may independently exchange the transaction information with a payment terminal without network access, so as to complete payment. For example, the payment card application running on the mobile terminal includes Apple Pay, Huawei Pay, or the like.

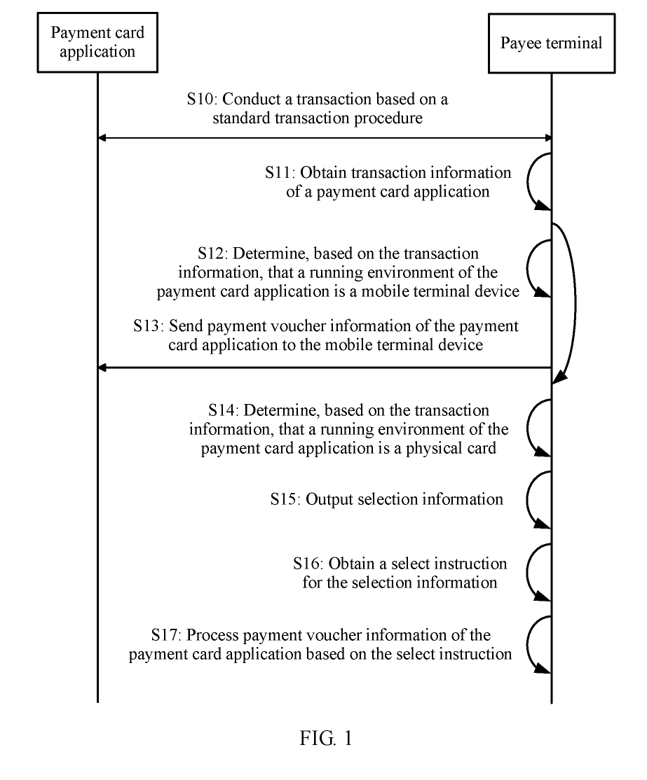

Referring to FIG. 1, FIG. 1 is an interaction flowchart of a payment processing method according to an embodiment of the present invention. As shown in FIG. 1, procedure interaction in this embodiment of the present invention includes but is not limited to the following steps.

S10: A payment card application conducts a transaction based on a standard transaction procedure.

S11: A payee terminal obtains transaction information of the payment card application.

The payee terminal determines, based on the transaction information, that a running environment of the payment card application is a mobile terminal device or a physical card. If the payee terminal determines that the running environment of the payment card application is the mobile terminal device, step S12 and step S13 are performed. If the payee terminal determines that the running environment of the payment card application is the physical card, step S14 to step S17 are performed.

S12: The payee terminal determines, based on the transaction information, that a running environment of the payment card application is a mobile terminal device.

S13: The payee terminal sends payment voucher information of the payment card application to the mobile terminal device.

S14: The payee terminal determines, based on the transaction information, that a running environment of the payment card application is a physical card.

S15: The payee terminal outputs selection information, where the selection information is used to instruct a user to select a processing manner of processing payment voucher information of the payment card application.

S16: The payee terminal obtains a select instruction for the selection information, and determines the processing manner corresponding to the select instruction.

S17: Process the payment voucher information of the payment card application based on the select instruction.

In an embodiment, a transaction is conducted between the payment card application and the payee terminal based on a transaction procedure in the EMVCo standard or the PBOC standard. Optionally, the payee terminal may be a POS machine. For example, the payee terminal (POS machine) sends an instruction to a payment end card application (the running environment of the payment card application may be the physical card or the mobile terminal device), and obtains the transaction information fed back by the payment card application. Specifically, optionally, a payment terminal sends a select instruction, a read record instruction, a get processing options (Get Processing Options, GPO) instruction, or the like according to the EMVCo standard or the PBOC standard, and the payment card application returns the transaction information to the payee terminal.

Optionally, the transaction information includes at least a personal account number (Personal Account Number, PAN) of the payment card application, and may further include a cardholder verification method list (Cardholder Verification Method List, CVM List) and/or card verification results (Card Verification Results, CVR). The payee terminal performs transaction payment processing based on the transaction information. After determining that a transaction is successfully processed, the payee terminal needs to process the payment voucher information of the payment card application. For example, currently in the industry, the payment voucher information is usually printed. This manner wastes resources and is inconvenient to manage. This embodiment of the present invention provides a payment processing method, so that running environments of the payment card application may be distinguished, and different processing manners are used when the payment card application is in different running environments. For example, when the running environment of the payment card application is the mobile terminal device, it indicates that electronic payment voucher information may be sent to the mobile terminal, so that the user conveniently manages and views the electronic payment voucher information by using the mobile terminal. For another example, when the running environment of the payment card application is the physical card, the user may select a manner of processing the payment voucher information. If the user takes a mobile phone along, electronic payment voucher information may be sent to a mailbox bound by the user. Alternatively, if the user does not take a mobile phone along, paper electronic payment voucher information may be printed. In this way, the user conveniently gets post-sales processing in time.

Specifically, optionally, a determining manner in which the payee terminal determines, based on the transaction information, that the running environment of the payment card application is the mobile terminal device may include but is not limited to the following three optional implementations.

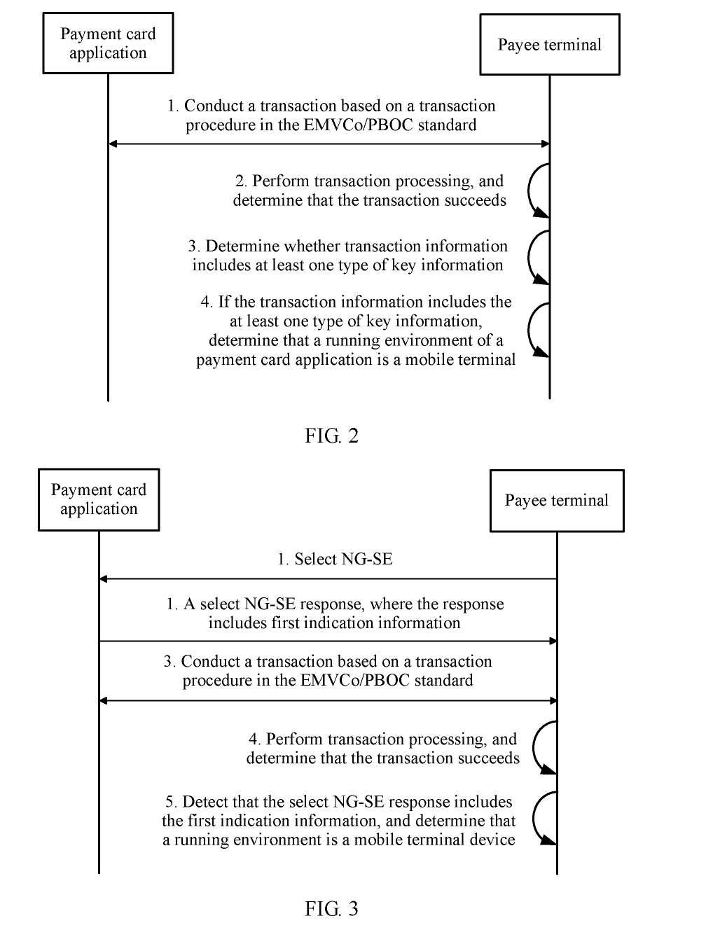

In a first optional implementation, referring to FIG. 2, the determining manner, in this implementation, of determining that the running environment of the payment card application is the mobile terminal device includes but is not limited to the following four steps:

1. The payment card application conducts a transaction based on the transaction procedure in the EMVCo standard or the PBOC standard.

2. The payee terminal performs transaction processing, and determines that the transaction succeeds.

3. The payee terminal detects whether the transaction information includes at least one type of key information, where types of the key information include: indication information used to indicate that the payment card application supports a terminal cardholder verification method, indication information used to indicate that the payment card application is successfully verified by a terminal cardholder, and digital information that meets a preset encoding rule and that is included in a personal account number PAN of the payment card application.

4. If the transaction information includes the at least one type of key information, the payee terminal determines that the running environment of the payment card application is the mobile terminal device.

Optionally, the terminal cardholder verification method is a cardholder identity verification method applicable only to a terminal, and a cardholder identity verification method that is not applicable to a physical card. For example, a cardholder identity verification method based on fingerprint recognition is a terminal cardholder verification method, and the cardholder identity verification method based on fingerprint recognition is not applicable to a physical card. A cardholder identity verification method based on password entering is not a cardholder identity verification method applicable only to a terminal, because a physical card is also applicable to the cardholder verification method.

Specifically, optionally, the payee terminal obtains the cardholder verification method list CVM List, and determines whether the cardholder verification method list includes a consumer device cardholder verification method (Consumer Device Cardholder Verification Method, CD-CVM) option. The CD-CVM option is indication information used to indicate that the payment card application supports the terminal cardholder verification method. If the CVM list includes the CD-CVM option, it is determined that the running environment of the payment card application is the mobile terminal device. If the CVM list does not include the CD-CVM option, the running environment of the payment card application cannot be determined.

A verification result corresponding to that the payment card application supports the terminal cardholder verification method may be used to indicate whether the payment card application is successfully verified by using the terminal cardholder verification method. For example, a cardholder is verified by using a fingerprint recognition method. If the payment card application is successfully verified by using the cardholder verification method based on fingerprint recognition, the transaction information may include indication information used to indicate that the payment card application is successfully verified by the terminal cardholder.

Specifically, optionally, the payee terminal determines whether the transaction information obtained from the payment terminal includes CVR data. The CVR data is indication information used to indicate that the payment card application is successfully verified by the terminal cardholder. If the transaction information includes the CVR data, it is determined that the running environment of the payment card application is the mobile terminal device. If the transaction information does not include the CVR data, the running environment of the payment card application cannot be determined.

The transaction information may include two types of indication information: both the indication information used to indicate that the payment card application supports the terminal cardholder verification method and the indication information used to indicate that the payment card application is successfully verified by the terminal cardholder. Alternatively, the transaction information includes only one of the foregoing two types of indication information. Alternatively, the transaction information includes neither of the foregoing two types of indication information. When the transaction information includes neither of the foregoing two types of indication information, it does not indicate that the running environment of the payment card application is not the mobile terminal device, and the running environment of the payment card application further needs to be determined based on other information in the transaction information. If at least one of the foregoing two types of indication information exists in the transaction information, it may be determined that the running environment of the payment card application is the mobile terminal device.

The personal account number PAN is a number used to identify a personal account. For example, a digit sequence with more than 10 digits that is displayed on a bank card is the personal account number. It should be noted that when the bank card is added to the payment card application of the mobile terminal, when a transaction is conducted between the payment card application and the payee terminal, a personal account number PAN provided by the payment card application to the payee terminal is different from the personal account number PAN of the bank card. For example, the personal account number of the bank card is referred to as a PAN 1. When a transaction is conducted between the payment card application and the payee terminal, the personal account number of the bank card provided by the payment card application to the payee terminal is a PAN 2. A value of the PAN 2 is different from a value of the PAN 1. However, a correspondence between the value of the PAN 2 and the value of the PAN 1 is stored in a payee end server corresponding to the payee terminal. Each time the payment card application is reinstalled on the mobile terminal or the bank card is registered on different mobile phones, the PAN 2 is changed. In addition, a validity period of the PAN 2 is shorter than a validity period of the PAN 1, the validity period of the PAN 2 is automatically updated after the validity period expires, and the server also constantly updates the correspondence between the value of the PAN 2 and the value of the PAN 1.

If a transaction is conducted between a physical card (for example, a bank card) and the payee terminal, when the transaction is conducted between a payment card application running on the physical card and the payee terminal, a personal account number PAN provided by the payment card application to the payee terminal is still a personal account number PAN 1 of the physical card.

To conveniently distinguish whether the running environment of the payment card application conducting a transaction is the physical card or the mobile terminal, this embodiment of the present invention provides a value of the PAN 2 encoded and processed according to the preset encoding rule. The preset encoding rule may be preset on the payee terminal. The payee terminal may directly determine the running environment of the payment card application by using the personal account number provided by the payment card application. If the personal account number includes the digital information that meets the preset encoding rule, it is determined that the running environment of the payment card application is the mobile terminal device. If the personal account number does not include the digital information that meets the preset encoding rule, it is determined that the running environment of the payment card application is the physical card.

Optionally, the preset encoding rule includes but is not limited to that a value of a specific digit segment in the value of the PAN 2 meets a specific range rule. For example, the preset encoding rule is that a value of a sixth digit to a ninth digit in the value of the PAN 2 is between 0000 and 3000. Further optionally, the preset encoding rule may be that a plurality of preset rules are set, and first several different digits in the value of the PAN 2 correspond to different preset rules. For example, when a value of first five digits is 622202, a preset rule 1 is correspondingly used, and when a value of first five digits is 621234, a preset rule 2 is correspondingly used. A value of first several digits is used to identify a bank, such as the Industrial and Commercial Bank of China or the China Merchants Bank. Different banks have respective defined preset rules. Therefore, during determining, based on the personal account number, whether the running environment of the payment card application is the physical card or the mobile terminal device, a bank to which the bank card conducting a transaction belongs first needs to be determined based on the first several digits of the personal account number, and a preset rule is then determined based on the bank to which the bank card belongs, and the running environment of the payment card application is further determined according to the preset rule.

The payee terminal may determine, by using at least one of the foregoing key information, whether the running environment of the payment card application is the mobile terminal device or the physical card.

In a second optional implementation, referring to FIG. 3, the determining manner, in this implementation, of determining that the running environment of the payment card application is the mobile terminal device includes but is not limited to the following five steps:

1. The payee terminal sends a select NG-SE instruction to the payment card application.

2. The payment card application sends a select NG-SE response to the payee terminal, where the select NG-SE response includes first indication information, and the first indication information is used to indicate that the running environment of the payment card application is the mobile terminal device.

3. Another contactless transaction procedure is performed between the payment card application and the payee terminal based on the EMVCo standard or the PBOC standard.

4. The payee terminal performs transaction processing, and determines that the transaction succeeds.

5. The payee terminal detects that the select NG-SE response includes the first indication information used to indicate that the running environment of the payment card application is the mobile terminal device, and determines that the running environment of the payment card application is the mobile terminal device.

An existing EMVCo/PBOC contactless payment standard is specified by two standard organizations for a smart card, and is relatively limited in terms of a service capability and a procedure. For example, a proximity payment system environment (Proximity Payment System Environment, PPSE) is a near field payment execution environment defined in the EMVCo standard and the PBOC standard, and mainly includes an AID list (a ranking represents a priority) supported by a payment end.

To comply with development of the payment industry, especially appearance of the payment card application running on the mobile terminal device (in other words, a compute capability of the payment end is relatively greatly improved), the EMVCo puts forward concepts of an NG architecture and an NG SE. In the document Next Gen Architecture Overview 1.0 published by the EMVCo, in descriptions of the NG SE, described characteristics of the NG SE may include the most fundamental information to information of more types, to support payment requirements of a conventional payment application to various new payment applications. Specific information that may be included in the NG SE is not limited, and only some examples are provided, for example, an amount of money and whether offline payment is supported. It is put forward in this embodiment of the present invention that, the NG SE response carries the first indication information used to indicate that the running environment of the payment card application is the mobile terminal device.

Specifically, optionally, the payee terminal sends the select NG-SE to the payment card application, and receives the select NG-SE response returned by the payment card application. The select NG-SE response may include the first indication information indicating that the running environment of the payment card application is the mobile terminal device.

The payee terminal determines, based on whether the select NG-SE response includes the first indication information, whether the running environment of the payment card application is the physical card or the mobile terminal device. For example, if the select NG-SE response includes the first indication information, it is determined that the running environment of the payment card application is the mobile terminal device. If the select NG-SE response does not include the first indication information, it is determined that the running environment of the payment card application is the physical card. Alternatively, if the running environment of the payment card application is the physical card, the select NG-SE response may include indication information used to indicate that the running environment of the payment card application is the physical card, and the payee terminal may determine, based on that the select NG-SE response includes the indication information used to indicate that the running environment of the payment card application is the physical card, that the running environment of the payment card application is the physical card.

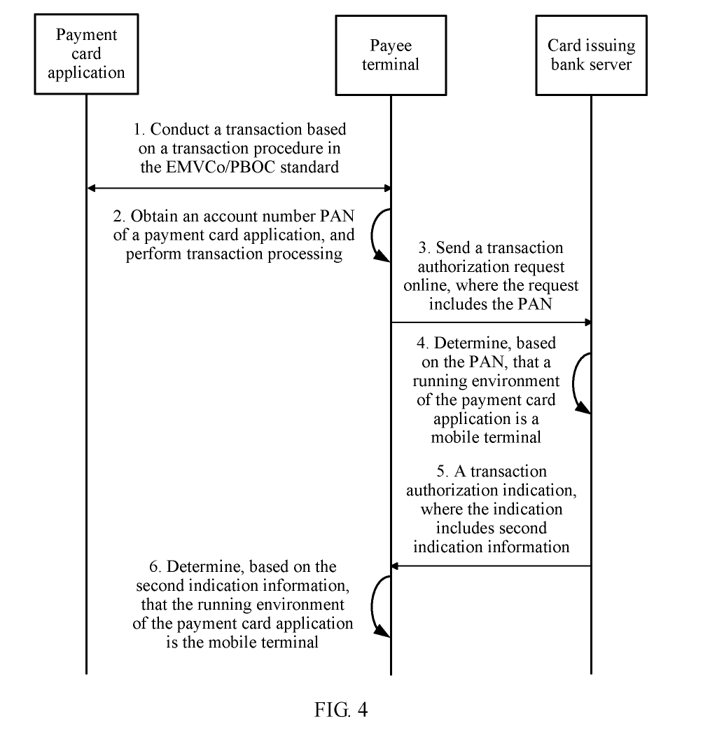

In a third optional implementation, referring to FIG. 4, the determining manner, in this implementation, of determining that the running environment of the payment card application is the mobile terminal device includes but is not limited to the following six steps:

1. A transaction is conducted between the payment card application and the payee terminal based on the transaction procedure in the EMVCo standard or the PBOC standard.

2. The payment terminal obtains an account number PAN of the payment card application, and performs transaction processing.

3. The payee terminal establishes a data connection to a card issuing bank server, and sends a transaction authorization request, where the transaction authorization request includes the account number PAN of the payment card application.

4. The card issuing bank server determines, based on the PAN, that the running environment of the payment card application is the mobile terminal device or the physical card.

5. If the card issuing bank server determines that the running environment of the payment card application is the mobile terminal device, the card issuing bank server returns a transaction authorization indication to the payee terminal, where the transaction authorization indication includes second indication information, and the second indication information is used to indicate that the running environment of the payment card application is the mobile terminal device; or

if the card issuing bank server determines that the running environment of the payment card application is the physical card, the card issuing bank server returns a transaction authorization indication to the payee terminal, where the transaction authorization indication includes third indication information, and the third indication information is used to indicate that the running environment of the payment card application is the physical card.

6. The payee terminal receives the transaction authorization indication returned by the card issuing bank server, and determines, based on the second indication information in the transaction authorization indication, that the running environment of the payment card application is the mobile terminal device, or determines, based on the third indication information in the transaction authorization indication, that the running environment of the payment card application is the physical card.

Optionally, transaction processing is performed between the payment card application and the payee terminal based on the EMVCo/PBOC standard, the payee terminal obtains an identifier of the payment card application, and the card issuing bank server stores a correspondence between the identifier of the payment card application and the running environment. Therefore, the card issuing bank server may determine the running environment of the payment card application based on the identifier of the payment card application.

Optionally, the identifier may be the personal account number PAN of the payment card application. It should be noted that if the running environment of the payment card application is the mobile terminal device, a value of the personal account number PAN that is of the payment card application and that is obtained by the payee terminal is different from a value of a PAN of a bank card added to the payment card application. If the running environment of the payment card application is the physical card, a value of the personal account number PAN that is of the payment card application and that is obtained by the payee terminal is a personal account number PAN of the physical card running in the payment card application.

The card issuing bank server stores a correspondence between each PAN and a running environment. For example, a PAN 1 is the personal account number of the bank card, and a PAN 2 is a personal account number obtained after the bank card is added to the payment card application of the mobile terminal. Therefore, the card issuing bank server stores information indicating that a running environment corresponding to the PAN 1 is the physical card, and that a running environment corresponding to the PAN 2 is the mobile terminal device. When the payment card application of the mobile terminal device makes a payment by using the bank card, the personal account number obtained by the payee terminal is the PAN 2. When a payment is made by using the physical card, the personal account number obtained by the payee terminal is the PAN 1. Therefore, the card issuing bank server may distinguish between running environments of the payment card application based on the personal account number of a payment application uploaded by the payee terminal.

Specifically, optionally, the payee terminal sends a transaction authorization request to the card issuing bank server. The transaction authorization request includes the obtained personal account number of the payment card application. The transaction authorization request may further include an indication that the payee terminal supports processing electronic payment voucher information. The card issuing bank server performs transaction processing, and determines that the transaction is valid; determines, based on the personal account number of the payment card application, that the running environment of the payment card application is the mobile terminal device or the physical card. Optionally, the card issuing bank server may further obtain a reserved email address bound to the personal account number of the payment card application. The card issuing bank server sends the transaction authorization indication to the payee terminal. If the card issuing bank server determines that the running environment of the payment card application is the mobile terminal device, the transaction authorization indication includes the second indication information used to indicate that the running environment of the payment card application is the mobile terminal device. If the card issuing bank server determines that the running environment of the payment card application is the physical card, the transaction authorization indication includes the indication information used to indicate that the running environment of the payment card application is the physical card. Further optionally, the transaction authorization indication may further include the email address obtained by the card issuing bank server.

The payee terminal may determine, by using one or more of the foregoing three optional implementations, that the running environment of the payment card application is the mobile terminal device or the physical card.

For different determining results, the payee terminal may process the payment voucher information in different processing manners.

Optionally, if the payee terminal determines that the running environment of the payment card application is the mobile terminal device, electronic payment voucher information (e-Receipt) is generated and sent to the mobile terminal device.

Optionally, the payee terminal may send, by using a second communications technology, the payment voucher information to an account bound to the personal account number of the payment card application, such as an instant messaging account number, a mobile number, or an email address, where the second communications technology includes but is not limited to a cellular communications technology, a wired communications technology, and a wireless local area network Wi-Fi technology; and/or

the payee terminal may send the payment voucher information of the payment card application to the mobile terminal device by using a first communications technology, where the first communications technology may be a short range communications technology, and for example, the first communications technology is a near field communication (Near Field Communication, NFC) technology or a Bluetooth technology. Optionally, when sending the payment voucher information to the mobile terminal device by using the short range communications technology, the payee terminal may further send, by using an email, the payment voucher information to the email address bound to the personal account number of the payment card application. The email address bound to the personal account number of the payment card application may be obtained by searching a payee end server corresponding to the payee terminal. Alternatively, the email address bound to the personal account number of the payment card application may be obtained by using the mobile terminal device. For example, the select NG-SE response returned by the mobile terminal device to the payee terminal carries the email address. Alternatively, the user may enter the email address to the payee terminal on the spot, the payee terminal uploads the email address to the payee end server, and the payee end server stores a correspondence between the personal account number of the payment card application and the email address.

Specifically, optionally, a sending manner in which the payee terminal sends the payment voucher information of the payment card application to the mobile terminal device based on the NFC technology may include but is not limited to the following optional implementations:

a. The payee terminal is used as a card reader, and sends the e-receipt to the mobile terminal device.

b. The payee terminal is currently disconnected from the mobile terminal device, re-establishes a point-to-point (Point-to-Point, P2P) connection, and sends the e-receipt to the mobile terminal device.

c. The payee terminal is currently disconnected from the mobile terminal device, the payee terminal uses the e-receipt as tag simulation content, and the mobile terminal device is used as a card reader to read the tag simulation content.

Optionally, the payee terminal may alternatively exchange handover information of a target bearer connection with the mobile terminal device based on the NFC technology, and re-establishes the target bearer connection to the mobile terminal device based on the handover information. The payee terminal sends the payment voucher information of the payment card application to the mobile terminal device over the target bearer connection. The target bearer connection is a short range communication connection other than the NFC.

For example, the target bearer connection is a Bluetooth connection. The payee terminal exchanges handover information of the Bluetooth connection with the mobile terminal device, establishes the Bluetooth connection between the payee terminal and the mobile terminal device based on the handover information, and sends the e-receipt to the mobile terminal device by using the established Bluetooth connection.

Optionally, if the payee terminal determines that the running environment of the payment card application is the physical card, the payee terminal may output selection information. The selection information is used to instruct the user to select a processing manner of processing the payment voucher information of the payment card application. For example, the selection information is used to instruct the user to select a paper payment voucher and/or an electronic payment voucher.

The user may perform selection for the selection information. The payee terminal obtains a select instruction that is used by the user for the selection information, and determines the processing manner corresponding to the select instruction. For example, if a select instruction indicating that the user selects the paper payment voucher is detected, the payee terminal prints the payment voucher information of the payment card. If a select instruction indicating that the user selects the electronic payment voucher is detected, the payee terminal sends, by using the second communications technology, the payment voucher information of the payment card to a receiving account bound to the physical card, such as an email address. If a select instruction indicating that the user selects an electronic payment voucher and a paper payment voucher is detected, the payee terminal prints the payment voucher information of the payment card, and sends, by using the second communications technology, the payment voucher information of the payment card to the receiving account bound to the physical card.

The second communications technology includes but is not limited to a cellular communications technology, a wired communications technology, and a wireless local area network (Wireless Fidelity, Wi-Fi) technology.

In this embodiment of the present invention, during transaction processing between the payee terminal and the payment card application, the payee terminal obtains the transaction information of the payment card application. The payee terminal further determines, based on the transaction information, that the running environment of the payment card application is the mobile terminal device. The payee terminal sends the payment voucher information of the payment card application to the mobile terminal device by using the short range communications technology. In this manner, when it is determined that the running environment of the payment card application is the mobile terminal device, it indicates that the user takes the mobile terminal device along. The payee terminal sends the payment voucher information of the payment card application to the mobile terminal device by default, so that the user conveniently manages and views the payment voucher information. In addition, a manner of sending the payment voucher information to the mobile terminal device by using the short range communications technology does not need to depend on network coverage, and has a wide application range.

The method in this embodiment of the present invention is described in detail above, and an apparatus in an embodiment of the present invention is provided below.

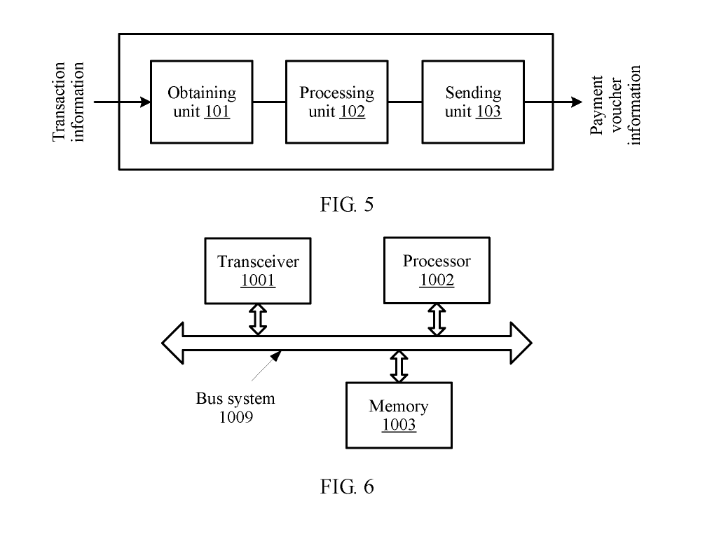

Referring to FIG. 5 and FIG. 6, FIG. 5 and FIG. 6 are schematic structural diagrams of payment processing apparatuses according to embodiments of the present invention. A payment processing apparatus in an embodiment of the present invention may be applied to the method embodiment in FIG. 1.

As shown in FIG. 5, the payment processing apparatus may include an obtaining unit 101, a processing unit 102, and a sending unit 103.

The obtaining unit 101 may be configured to perform a receiving action that is performed by a payee terminal and that is described in the foregoing method.

The sending unit 102 may be configured to perform a sending action that is performed by the payee terminal and that is described in the foregoing method.

The processing unit 103 may be configured to: perform corresponding processing, which is described in the foregoing method, on transaction information received by the obtaining unit 101; and/or perform corresponding processing, which is described in the foregoing method, on payment voucher information to be sent by the sending unit 102, and send the payment voucher information by using the sending unit 102.

The obtaining unit 101 and the sending unit 102 may be implemented by using a transceiver 1001 in FIG. 6. The processing unit 103 may be implemented by using a processor 1002, or implemented by using a processor 1002 and a memory 1003.

For specific details, refer to the descriptions in the foregoing method. The details are not described herein.

For example, the obtaining unit 101 is used by the payee terminal to obtain transaction information of a payment card application.

The processing unit 103 is configured to determine, based on the transaction information, that a running environment of the payment card application is a mobile terminal device.

The sending unit 102 is configured to send the payment voucher information of the payment card application to the mobile terminal device by using a first communications technology, where the first communications technology includes a short range communications technology.

Correspondingly, as shown in FIG. 6, FIG. 6 is a schematic structural diagram of another payment processing apparatus according to an embodiment of the present invention. The payment processing apparatus may include the transceiver 1001 and the processor 1002. The processor 1002 is configured to control an operation of the apparatus, and the operation includes: performing data transmission (including receiving and/or sending) by using the transceiver. The payment processing apparatus may further include the memory 1003. The memory 1003 may include a read-only memory and a random access memory, and is configured to provide an instruction and data for the processor 1002. The memory 1003 may be integrated into the processor 1002, or may be independent of the processor 1002. A part of the memory 1003 may also include a non-volatile random access memory (NVRAM). Components of the apparatus are coupled together by using a bus system. In addition to a data bus, the bus system 1009 includes a power bus, a control bus, and a status signal bus. However, for clarity of description, various buses are marked as the bus system 1009 in the figure.

The procedure disclosed in this embodiment of this application may be applied to the processor 1002, or is implemented by the processor 1002. During implementation, each step of the procedure implemented by the apparatus may be completed by using an integrated logical circuit of hardware in the processor 1002 or an instruction in a form of software. The processor 1002 may be a general purpose processor, a digital signal processor, an application-specific integrated circuit, a field programmable gate array or another programmable logic device, a discrete gate or transistor logic device, or a discrete hardware component, and may implement or execute the methods, steps, and logical block diagrams disclosed in the embodiments of this application. The general purpose processor may be a microprocessor or any conventional processor. The steps of the methods disclosed with reference to the embodiments of this application may be directly performed and completed by a hardware processor, or may be performed and completed by using a combination of hardware and software modules in the processor. The software module may be located in a mature storage medium in the art, such as a random access memory, a flash memory, a read-only memory, a programmable read-only memory, an electrically-erasable programmable memory, or a register. The storage medium is located in the memory 1003, and the processor 1002 reads information in the memory 1003 and implements, in combination with the hardware of the processor 1002, the steps of the procedure indicated in the embodiments of the present invention.

Further, when the apparatus is a payee terminal, the apparatus may further include an input device, such as a keyboard, an output device, a display, or another structure. Details are not described herein.

A person of ordinary skill in the art may understand that all or some of the procedures of the methods in the embodiments may be implemented by a computer program instructing relevant hardware. The program may be stored in a computer readable storage medium. When the program runs, the procedures of the methods in the embodiments are performed. The foregoing storage medium includes: any medium that can store program code, such as a ROM, a random access memory RAM, a magnetic disk, or an optical disc.

1. A payment processing method, comprising:
obtaining, by a payee terminal, transaction information of a payment card application;
determining, by the payee terminal based on the transaction information, that a running environment of the payment card application is a mobile terminal device; and
sending, by the payee terminal, payment voucher information of the payment card application to the mobile terminal device using a first communications technology, the first communications technology being a short range communications technology.

2. The method of claim 1, wherein sending the payment voucher information of the payment card application to the mobile terminal device comprises sending, by the payee terminal, the payment voucher information of the payment card application to the mobile terminal device based on a near field communication (NFC) technology.

3. The method of claim 1, wherein determining that the running environment of the payment card application is the mobile terminal device comprises:
detecting, by the payee terminal, whether the transaction information comprises at least one type of key information, types of the key information comprising indication information that the payment card application supports a terminal cardholder verification method, indication information indicating, that the payment card application is successfully verified by a terminal cardholder, and digital information meeting a preset encoding rule in a personal account number of the payment card application; and
determining, by the payee terminal, that the running environment of the payment card application is the mobile terminal device when the transaction information comprises the at least one type of key information.

4. The method of claim 1, wherein determining that the running environment of the payment card application is the mobile terminal device comprises:
detecting, by the payee terminal, whether the transaction information comprises first indication information, the first indication information indicating that the running environment of the payment card application is the mobile terminal device; and
determining, by the payee terminal, that the running environment of the payment card application is the mobile terminal device when the transaction information comprises the first indication information.

5. The method of claim 1, wherein determining that the running environment of the payment card application is the mobile terminal device comprises:
obtaining, by the payee terminal, an identifier of the payment card application from the transaction information;
uploading, by the payee terminal, the identifier of the payment card application to a server, in enable the server to determine, based on the identifier of the payment card application, that the running environment of the payment card application is the mobile terminal device; and
receiving, by the payee terminal, second indication information from the server, the second indication information indicating that the running environment of the payment card application is the mobile terminal device.

6. The method of claim 1, further comprising:
determining, by the payee terminal based on the transaction information, that the running environment of the payment card application is a physical card; and
processing, by the payee terminal, the payment voucher information of the payment card application, and
processing the payment voucher information of the payment card application comprising:
printing, by the payee terminal, the payment voucher information of the payment card application; and
sending, by the payee terminal using a second communications technology, the payment voucher information of the payment card application to a receiving account bound to the physical card, the second communications technology being any one of a cellular communications technology, a wired communications technology, or a wireless local area network WI-FI technology.

7. The method of claim 6, wherein before processing the payment voucher information of the payment card application, the method further comprises:
outputting, by the payee terminal, selection information, the selection information instructing a user to select a processing manner of processing the payment voucher information of the payment card application;
obtaining, by the payee terminal, a select instruction for the selection information; and
determining, by the payee terminal, the processing manner corresponding to the select instruction.

8. A payment processing apparatus, comprising:
a memory storing instructions; and
the processor coupled to the memory, the instructions causing the processor to be configured to:
obtain transaction information of a payment card application;
based on the transaction information, that a running environment of the payment card application is a mobile terminal device; and
send payment voucher information of the payment card application to the mobile terminal device using a first communications technology, the first communications technology being a short range communications technology.

9. The apparatus of claim 8, wherein the instructions further cause the processor to be configured to send the payment voucher information of the payment card application to the mobile terminal device based on a near field communication (NFC) technology.

10. The apparatus of claim 8, wherein the instructions further cause the processor to be configured to:
detect whether the transaction information comprises at least one type of key information, types of the key information comprising indication information indicating that the payment card application supports a terminal cardholder verification method, indication information indicating that the payment card application is successfully verified by a terminal cardholder, and digital information meeting a preset encoding rule in a personal account number of the payment card application; and
determine that the running environment of the payment card application is the mobile terminal device when the transaction information comprises the at least one type of key information.

11. The apparatus of claim 8, wherein the instructions further cause the processor to be configured to:
detect whether the transaction information comprises first indication information, the first indication information is indicating that the running environment of the payment card application is the mobile terminal device; and
determine that the running environment of the payment card application is the mobile terminal device when the transaction information comprises the first indication information.

12. The apparatus of claim 8, wherein the instructions further cause the processor to be configured to:
obtain an identifier of the payment card application from the transaction information;
upload the identifier of the payment card application to a server to enable the server to determine, based on the identifier of the payment card application, that the running environment of the payment card application is the mobile terminal device; and
receive second indication information from the server, the second indication information indicating that the running environment of the payment card application is the mobile terminal device.

13. The apparatus of claim 8, wherein the instructions further cause the processor to be processing configured to:
determine, based on the transaction information, that the running environment of the payment card application is a physical card; and
process the payment voucher information of the payment card application, and
in a manner of processing the payment voucher information of the payment card application, the instructions further causing the processor to be configured to:
print the payment voucher information of the payment card application; and
send, using a second communications technology, the payment voucher information of the payment card application to a receiving account bound to the physical card, the second communications technology being any one of a cellular communications technology, a wired communications technology, or a wireless local area network WI-FI technology.

14. The apparatus of claim 13, wherein before processing the payment voucher information of the payment card application, the instructions further cause the processor to be configured to:
output selection information, the selection information instructing a user to select a processing manner of processing the payment voucher information of the payment card application;
obtain a select instruction for the selection information; and
determine the processing manner corresponding to the select instruction.

15. The method of claim 1, wherein sending the payment voucher information of the payment card application to the mobile terminal device comprises:
exchanging, by the payee terminal, handover information of a target bearer coupling based a near field communication (NFC) technology;
re-establishing, by the payee terminal, the target bearer coupling to the mobile terminal device based on the handover information; and
sending, by the payee terminal, the payment voucher information of the payment card application to the mobile terminal device over the target bearer coupling, the target bearer coupling being a short range communication coupling other than the NFC.

16. The method of claim 1, further comprising:
determining, by the payee terminal based on the transaction information, that the running environment of the payment card application is a physical card; and
processing, by the payee terminal, the payment voucher information of the payment card application, and
processing the payment voucher information of the payment card application comprising printing, by the payee terminal, the payment voucher information of the payment card application.

17. The method of claim 1, further comprising:
determining, by the payee terminal based on the transaction information, that the running environment of the payment card application is a physical card; and
processing, by the payee terminal, the payment voucher information of the payment card application, and
processing the payment voucher information of the payment card application comprising sending, by the payee terminal using a second communications technology, the payment voucher information of the payment card application to a receiving account bound to the physical card, the second communications technology being any one of a cellular communications technology, a wired communications technology, or a wireless local area network WI-FI technology.

18. The apparatus of claim 8, wherein the instructions further cause the processor to be configured to:
exchange handover information of a target bearer coupling based on a near field communication (NFC) technology;
re-establish the target bearer coupling to the mobile terminal device based on the handover information; and
send the payment voucher information of the payment card application to the mobile terminal device over the target bearer coupling, the target bearer coupling being a short range communication coupling other than the NFC.

19. The apparatus of claim 8, wherein the instructions further cause the processor to be configured to:
determine, based on the transaction information, that the running environment of the payment card application is a physical card; and
process the payment voucher information of the payment card application, and
in a manner of processing the payment, voucher information of the payment card application, the instructions further causing the processor to be configured to print the payment voucher information of the payment card application.

20. The apparatus of claim 8, wherein the instructions further cause the processor to be configured to:
determine, based on the transaction information, that the running environment of the payment card application is a physical card; and
process the payment voucher information of the payment card application, and
in a manner of processing the payment voucher information of the payment card application, the instructions further causing the processor to be configured to send, using a second communications technology, the payment voucher information of the payment card application to a receiving account bound to the physical card, the second communications technology being any one of a cellular communications technology, a wired communications technology, or a wireless local area network WI-FI technology.
